(19) United States
(12) Patent Application Publication
(10) Pub. No.: US 2009/0228294 A1
(43) Pub. Date: Sep. 10, 2009

(54) METHOD AND SYSTEM FOR ON-LINE IDENTIFICATION ASSERTION

(75) Inventors: Joon Nak Choi, Stanford, CA (US); Kevin Trilli, San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: ASSERTID INC., San Francisco, CA (US)

(21) Appl. No.: 12/262,053

(22) Filed: Oct. 30, 2008

Related U.S. Application Data
(60) Provisional application No. 61/035,330, filed on Mar. 10, 2008.

(51) Int. Cl. G06Q 99/00

(52) U.S. Cl. 705/1; 705/35

(57) ABSTRACT

Self-asserted socio-demographic attributes of individuals' identities are verified using social network analysis and other means. Through these processes, parties to a transaction or interaction arc provided a measure of confidence about another party's self-asserted socio-demographic attributes, such as age, gender, marital status, etc., in order to assist in determining whether or not to pursue the transaction or interaction. The measure of confidence may be provided as a quantitative “score” indicative of the likelihood the user's self-asserted attribute is actually true. The quantitative score is derived by analyzing a web of trust in which the user is embedded.

### RELATED APPLICATION

This application is a NONPROVISIONAL of and claims priority to U.S. Provisional Patent Application 61/035,330, filed Mar. 10, 2008, incorporated herein by reference.

### FIELD OF THE INVENTION

The present invention relates to methods and systems for verifying on-line identities and, more particularly, attributes of such identities (e.g., age, geographic location, etc.), using social network analysis and other means.

### BACKGROUND

A. Introduction

“On the Internet, nobody knows you're a dog.” This caption from Peter Steiner's infamous cartoon, printed at page 61 of the Jul. 5, 1993 issue of The New Yorker (Vol. 69, no. 20) and featuring two computer-savvy canines, embodies the essence of a serious problem in modern society. Although an ever-growing number of commercial and social transactions take place across electronic mediums, little if anything has been done to assist users of those mediums ensure that thc other parties to those transactions are who they purport to be. That is, users of Web-based social networking sites, job hunting sites, dating sites, consumer-to-consumer commercial transactions sites, and a myriad of other, so-called Web 2.0 sites, have few, if any, means for verifying the identities or attributes of those they interact with in the on-line world.

Thus, the Web 2.0 revolution is built on an internal contradiction. The same technologies that have allowed companies to create borderless, virtual communities buzzing with social interaction and provide innovative and convenient ways for people to transact business, also prevent their users from knowing just who it is they are dealing with in those interactions. As a result, newspapers and other media outlets report stories of sexual predators prowling social networks, preying on the young and innocent; bigots troll the forums, misleading and bullying community members; con artists haunt the marketplaces, defrauding on-line buyers and sellers; and members of on-line dating sites complain of dates who lie about their marital status, or look nothing like their posted photos. By enabling anonymous social interactions that foster creativity and connectivity, Web 2.0 enterprises unintentionally create opportunities for abuse at the same time.

B. Trust in Social Interactions

Whenever two people interact, they expect certain things from each other. Consider an example involving the purchase and sale of an article such as a laptop computer via an on-line commerce site. When the buyer and seller agree to the transaction, the buyer impliedly (or perhaps explicitly) promises to pay in a timely manner, and the seller (impliedly or explicitly) promises to send a product as advertised. In many cases, the buyer must believe the seller's promise (i.e., must trust the seller), and send payment before receiving the laptop computer. This involves a certain amount of risk: if the seller plans on abusing the buyer's trust, s/he could take the buyer's money without ever sending the laptop.

This example illustrates two important aspects of trust. Just like in the physical world, trust in the on-line world is often misplaced; not everyone honors promises. Second, trust creates the conditions for its own abuse; a person cannot be duped unless she trusts a scammer in the first place. Consequently, interactions present a social dilemma. For an interaction to occur, one of the two parties must act, trusting that the other party will honor her/his promises. Someone needs to make the first move.

For these reasons, people generally withhold trust unless they know something about another's trustworthiness. Most adults have an inner circle of trust: friends, family and close colleagues who have already proven trustworthy. They also tend to trust people who have been vouched for by a friend, or who have excellent reputations. In countries with strong legal systems, people will generally trust others to obey the law, at least in the absence of very strong incentives to break it. In contrast, reasonable adults typically distrust strangers in an off-line setting.

C. The Benefits of Radical Trust

Paradoxically, the same people who distrust real-life strangers often trust strangers in an on-line setting. They blog about intimate moments (revealing intimate details of their lives to anyone who cares to read about them), purchase items from unknown sellers (exposing themselves to fraud), and even swap homes with strangers. This is especially strange considering that face-to-face interactions provide far more signals about trustworthiness than on-line interactions. Body language, tones of voice and even the way someone is dressed all convey information relevant to questions of trust in the physical world. Some communication experts go as far as to suggest that 80% of face-to-face communication occurs through such non-verbal cues. Yet, people seem to trust on-line strangers more than offline ones. Why is this? Part of the answer lies in radical trust—the belief that on-line community members should trust each other unconditionally.

Web 2.0 companies understand that they can build stronger communities—and generate greater value—by facilitating trust amongst community members. Many such companies live by O'Reilly's dictum: facilitate user interactions, and success will follow. Building community-wide trust is an important part of this process. Largely because they have fostered radical trust, Web 2.0 entities have grown tremendously.

D. The Dark Side of Radical Trust

However, radical trust has a dark side that is jeopardizing these achievements. Like any other form of trust, radical trust creates the conditions for its own abuse. If a community member (“Andy”) trusts another (“Brad”) to behave in a specified way, Brad can take advantage of Andy. Suppose that Andy is looking for a hotel room in a vacation spot, and so is reading reviews posted to an on-line travel advisory site before making a decision, and Brad is the proprietor of a motel in the area. Knowing that most readers of the on-line advisory site trust user reviews, Brad posts anonymous and misleading reviews of his run-down motel. Andy, trusting the community nature of the site, believes the review, visits Brad's motel, and ends up having a wholly unsatisfactory experience. Many users of on-line travel advisory sites complain about just such experiences and similar problems are found across several different kinds of Web 2.0 sites:

1. User-generated content sites: Websites based on user-generated content (e.g., collaborative filtering sites, message boards, etc.) operate on an implicit assumption: content users can trust content providers to post accurate information. However, many people (like unscrupulous hotel proprietors) have an incentive to post misleading information. Notably, finance message boards are reputed to be flooded with false rumors and information intended to influence trading decisions that benefit the posters of the information.

2. On-line dating sites: Like user-generated content sites, on-line dating sites depend on their users to provide accurate information. However, many on-line daters have incentives to embellish, omit or enhance important details (e.g., marital status or appearance). Thus, they post false information about themselves or photos taken when they were younger or in much better physical shape. Many on-line daters complain about such experiences. Additionally, dating sites need to very careful not to allow anyone under the age of 18 into their sites to protect their users from potentially illegal contact with minors via their forums.

3. Social networking sites: Social network businesses face a homologous problem; they depend on their users to post accurate profiles. Unlike the situation for on-line dating scenarios, not all profile misrepresentations have negative effects; users often post ridiculous ages (e.g., 99) or locations (e.g., Antarctica) as a joke. Yet, not all misrepresentations are harmless. Sexual predators often disguise themselves as children to gain their targets' confidence. Indeed, such practices are alarmingly widespread. A study by the National Center for Missing and Exploited Children found that 13% of all children using social network sites received unwanted sexual solicitations. Nearly a third of these solicitations were aggressive, meaning that the solicitor attempted to meet the child off-line. Additionally, 4% of children on-line were asked for nude pictures of themselves. ISAFE, a not-for-profit organization specializing in educating children on Internet safety, conducted a study that has shown the 1 in 5 children in grades 5-12 have met in person with someone they had originally met on-line. Additionally, with social network profiles and applications/widgets functioning much like business websites, spam is taking on a new form, sent by a supposed “friend” to an unknowing user.

4. Commercial transaction sites: Auction sites and on-line marketplaces face a slightly different problem. Transactions are only possible if sellers trust buyers to pay, and buyers trust sellers to deliver. However, both sellers and buyers face strong incentives to cheat. Although some on-line marketplaces have instituted countermeasures designed to punish cheaters, some types of abuse have nevertheless become commonplace, reducing the overall integrity of all such sites. For instance, shill bidding has pervaded on-line auction sites. in this practice, the seller (or someone in collusion therewith) registers fake bids on items for sale in order to prompt potential buyers into submitting higher bids. Also, high-reputation accounts (i.e., those which seemingly are associated with trustworthy individuals based on a marketplace reputation score) are available for purchase by fraudsters looking to make a quick sale of an expensive product to an unwitting buyer.

5. Content providers. Radical trust can also extend to businesses interacting with consumers online. Providers of content intended for adult audiences (typically defined as Internet users older than 18 years old) have a challenging problem enforcing age restrictions for their sites due to this same inability to know who is accessing their sites. Typically, younger users with personal incentives to view this content game the system to appear to be an adult by simply using someone else's valid credit card. Perhaps worse, many sites simply ask users to self-assert their ages without undertaking any sort of validation.

E. Existing Solutions and their Inadequacies

Recognizing that radical trust can be abused, on-line businesses and web visionaries have proposed several solutions. Unfortunately, each of these “solutions” possesses exploitable weaknesses.

1. Self-Regulation through Social Norms: Web 2.0 proponents propose that communities minimize abuse through self-regulation. In practice, self-regulation usually translates into a rhetorical exercise, where community leaders and the on-line business vigorously champion social norms (“community standards”) against abusive behaviors. While such practices are easy and inexpensive to initiate and maintain, they tend to foster a false sense or security which creates opportunities for even greater abuse.

2. Self-Regulation through Punitive Measures: A different kind of self-regulation involves punitive measures. A few on-line communities give their users the power to collectively rate each other. On many sites, bad ratings are linked with negative incentives. For instance, someone with a low rating on a commercial transaction site will have difficulty finding transaction partners, who are scared off by a bad “reputation”. Thus, collective ratings systems give community members the power to punish repeat abusers. Nevertheless, while these measures have tended to reduce abuse, they possess known loopholes that are virtually impossible to adequately police. Moreover, site operators have almost no way to deter or prevent malicious users from perpetuating frauds with fresh accounts.

3. Eliminating Web Anonymity: Compared with the off-line world, on-line communities offer an unprecedented amount of anonymity. To sign up for most on-line communities, users only need to present a valid e-mail address, available free from many different providers. Such addresses are virtually impossible to trace back to real-life individuals. As indicated above, for age verification most sites simply offer self-assertion, click-through agreements that push the age verification responsibility onto the user, without ever verifying that users' personal information.

Recognizing this problem, the South Korean government has outlawed on-line anonymity and now requires individuals to register their national identification numbers (equivalent to U.S. Social Security Numbers) with on-line communities they join. This requirement has reduced (but not eliminated) abusive practices. To eliminate abusive attacks altogether, the Korean government is implementing a “real names policy” where on-line community members will be identified by their real names, not on-line monikers. Already this “solution” has spawned other serious problems. Widespread usage of the national identification number has made it more vulnerable to theft, increasing identify theft across the country. More fundamentally, this requirement not only strips away the risks associated with Internet anonymity, but also its freedom-of-expression benefits. People are less inclined to voice unpopular opinions when they face physical-world retributions. Although Koreans were willing to give up this benefit, Americans are likely to place greater weight on these freedoms. Furthermore, a real-name policy conflicts with United States law, which prohibits the release of personal information about children under age 13. Thus, while a real-names policy may deter potential abusers from the most damaging trust abuses, it creates opportunities for widespread identity theft and is likely politically untenable in the United States.

4. Reputation Systems: A more sophisticated version of a real-names policy links an individual's real name with his/her on-line reputation(s). Much like reputation mechanisms employed by on-line auction sites, emerging reputation systems ask users to rate their interactions with one another. By providing such historical information, these companies attempt to address the Web 2.0 trust gap. Although groundbreaking in several ways, reputation systems face the same loopholes as less-sophisticated ratings systems, and they lack any means for truly verifying the user-provided data (e.g., the user's real name) outside of crawling publicly available websites for confirmation, which must be assumed to provide only self-asserted, un-trusted data. Thus, despite these efforts, users of these on-line services remain, for all practical purposes, anonymous.

This anonymity exposes a fundamental flaw in the reputation system model—community members with “bad” reputations can always start over with a new profile. Even worse, nothing stops a user from creating dozens of profiles (each under a different user name, for example), and using them to falsely enhance a fake profile's reputation through positive reviews. Just as importantly, users who register legitimate complaints face retaliation from their abusers.

Additionally, reputation system ratings are difficult to interpret. Unlike on-line auction site ratings, which cover interactions occurring in a well-defined marketplace, reputation systems generally attempt to create a unified reputation spanning multiple social spheres. Unfortunately, a user's reputation in one sphere may not be relevant in another. Often, reputations are subjective and require a great deal of interpretation. Thus, reputation ratings have the potential for creating more confusion than they alleviate and while they may reduce sonic information shortfalls (because individuals may act to protect their reputations), it remains virtually impossible to deter malicious users from starting over with a fresh account.

5. MySpace™: MySpace has become one of the most popular social network sites for minors and faces particular problems in protecting these children against predation by child molesters. To combat this threat, MySpace has made all 14- and 15-year old members' profiles private, making them accessible only to the adolescent's immediate friends. Additionally, MySpace is trying to keep younger adolescents from being contacted by adult strangers. While admirable, this initiative is fundamentally flawed. On one hand, nothing stops a potential abuser from lying about his/her age in his/her profile. On the other, adolescents often claim that they are 18 or older, often as a direct reaction against restrictions that arc intended to protect them from potential predators. Without a means of verifying self-reported information, the MySpace initiative cannot succeed.

6. PGP's Web-of-Trust: An alternative model is based on physical-world notions of trust between individuals. Most people have an inner circle of trust, composed of friends, family and close colleagues. Such people might not trust strangers, unless a trusted confidante vouched for them. For instance, consider three people, Adam, Benjamin and Carol. Suppose Adam does not know anything about Carol, but trusts his close friend Benjamin, who in turn knows and trusts Carol. In this situation, Benjamin could introduce Carol to Adam as a trustworthy person. Using this principle, the PGP (Pretty Good Privacy) Web-of-Trust extends a network of trustworthy people to the on-line world. An individual can be connected with a stranger through a chain of trust, where each link represents a person vouching for another. This system can conceivably be adapted for wider usage within Internet communities. If an on-line system were to track people who vouched for each other, the members of this network could constitute an enlarged circle of trust. These people could even remain anonymous to each other.

Although intriguing, this concept is not as robust as it appears. The PGP Web-of-Trust connects two people using a single chain of individuals who vouch for each other. Consider then a situation where a single person in that chain misplaces his/her trust, mistakenly (or intentionally) vouching for someone who is not trustworthy. The untrustworthy individual can then vouch for other untrustworthy individuals, and the entire system collapses. Thus, the PGP Web-of-Trust could potentially be brought down by a single point of failure. Further, the method of vetting new members in a web of trust is handled in a one-on-one, in-person inspection of government-issued identity documents. This process is very difficult to scale beyond a few users and rollout in a global on-line community. Thus, while the Web-of-Trust leverages physical-world manifestations of interpersonal relationships and trust, it possesses no redundancy mechanisms leaving it vulnerable to a single point of failure (a breach of trust) that can collapse the overall system's integrity.

### SUMMARY OF THE INVENTION

The present invention provides methods and systems for verifying self-asserted socio-demographic attributes of individuals' identities, using social network analysis and other means. Through these processes, parties to a transaction or interaction are provided a measure of confidence about another party's self-asserted socio-demographic attributes, such as age, gender, marital status, etc., in order to assist in determining whether or not to pursue the transaction or interaction. The measure of confidence may be provided as a quantitative “score” indicative of the likelihood the user's self-asserted attribute is actually true. The quantitative score is derived by analyzing a web of trust in which the user is embedded.

In one embodiment of the invention, a quantitative measure of a trustworthiness of a self-asserted attribute of an individual is determined through a combination of analysis of a social network of which the individual is a member and non-network based analyses, and reporting said measure.

In a further embodiment of the invention, a credential is reported in response to receipt of a request therefor. The credential represents an estimate as to how likely a self-asserted attribute of an individual representing said attribute as true is in fact true. The estimate is computed through a plurality of mechanisms, including an examination of a web of trust within which the individual is embedded and non-network analysis based measures of the veracity of the attribute's asserted value.

The examination of the web of trust may include computing a contribution for embeddedness of the individual in the web of trust, for example computing contributions for direct and indirect embeddedness of the individual in the web of trust. The non-network analysis based measures may include identity measures which reward the individual for association with user profiles including difficult to replicable elements, and verification of the attribute with information obtained from trusted sources outside of the web of trust.

In sonic embodiments of the invention, the estimate is computed using weighted contributions for direct embeddedness of the individual in the web of trust, indirect embeddedness of the individual in the web of trust, embeddedness of the individual social in networks other than the web of trust, identity measures which reward the individual for association with user profiles including difficult to replicable elements, and verification of the attribute with information obtained from trusted sources outside of the web of trust. In some cases, contributions for direct embeddedness of the individual in the web of trust are determined according to a computation of the individual's centrality within the web of trust (e.g., using a modified version of indegree Bonacich centrality). Contributions for indirect embeddedness of the individual in the web of trust may likewise be determined according to a computation of the individual's centrality within the web of trust this time using a different modified version of indegree Bonacich centrality, including one modification limiting a total indirect embeddedness contribution per verifying member of the web of trust for the individual. The contributions for indirect embeddedness may be capped at a threshold so as to guard against undue contributions for redundant verification paths, etc.

In some instances the estimate is computed through a scoresheet approach in which the individual mechanisms by which trustworthiness of the self-asserted attribute is measured are each allocated a specific number of scoresheet points and a credential's score is a summed total of the scoresheet points. Contributions to the credential score for indirect embeddedness of the individual in the web of trust may make up a majority of the scoresheet points for the examination of a web of trust within which the individual is embedded. Contributions to the credential score attributable to verification of the attribute with information obtained from trusted sources outside of the web of trust may make up a single largest component of the scoresheet points.

A further embodiment of the present invention involves quantitatively measuring an individual's embeddedness within a social network and assigning a score thereto, combining that score with a quantitative measure of the veracity of the attribute's asserted value as determined through non-network based analysis to produce a combined score, and reporting the combined score as a measure of trustworthiness of a self-asserted attribute of the individual. In such cases, measuring the individual's embeddedness within the social network may include determining contributions for the individual's direct embeddedness and indirect embeddedness in the social network. As indicated above, a contribution for the individual's direct and indirect embeddedness in the social network may be determined by computing the individual's centrality within the social network. The non-network analysis may include a quantitative contribution for identity measures indicative of the individual's association with user profiles including difficult to replicable elements and/or verification of the attribute with information obtained from trusted sources outside of the social network. The combined score may be computed through the scoresheet approach in which each quantitative measure is allocated a contribution to the combined score up to a threshold.

These and other features of the present invention are described in detail below.

### BRIEF DESCRIPTION OF THE DRAWINGS

The present invention is illustrated by way of example, and not limitation, in the figures of the accompanying drawings, in which:

FIG. 1 illustrates relationships between participants of an interaction/transaction in the context of the present invention.

FIG. 2 illustrates varying relationships between credential holders, direct verifiers of the credential holders and indirect verifiers of the credential holders for two different network cases.

FIG. 3 illustrates differences in network relationships between a closely-knit group of individuals and a loosely knit group of individuals.

FIG. 4 illustrates differences in indegree Bonacich centrality between networks exhibiting significant closure and those exhibiting reduced degrees of closure.

### DETAILED DESCRIPTION

Described herein are methods and systems for verifying on-line identities and, more particularly, attributes of such identities, using social network analysis and other means. As used herein, the term “identity” is meant to encompass individual characteristics by which a thing or person is recognized or known. In one embodiment, these methods and systems are implemented so as to provide a measure of confidence about a user's self-asserted socio-demographic attributes, such as age, gender, marital status, etc., and make that measure available to others seeking to determine whether or not a user is who the user purports to be or possess attributes he/she purports to possess. The measure of confidence may be provided as a quantitative “score” indicative of the likelihood the user's self-asserted attribute is actually true. As used herein, the term likelihood is not intended to convey a probability but rather a measure defined by the algorithm discussed below. The quantitative score is derived in two stages: (1) building a web of trust amongst users of the service, and (2) computing those users' embeddedness within the web of trust.

Embodiments of the present invention may take the form of an on-line service having a front-end functioning as identity oracle, collecting and warehousing private information about on-line individuals, and a back-end that functions as a web-of-trust verifying self-asserted information about its users. The information so collected and verified can be made available (either in raw form or, preferably, in the form of or accompanied by the qualitative score) to answer questions or provide assurances about an individual's self-asserted attributes—in some cases without actually disclosing the private data. Consider a hypothetical example. A user (ID:123) applies to join Club Penguin, an on-line social network open only to minors. To determine whether or not 123 is really a minor, Club Penguin queries the identity oracle about 123's age. Because the identity oracle possesses private information about 123 (e.g., that he is John Doe, age 12, living at 123 Main Street in Anytown), the identity oracle is able to verify 123's age (either by releasing same to Club Penguin or simply by answer the query affirmatively) while keeping 123's other attributes private.

Among the features that set the present invention apart from solutions such as those discussed above is verification of users' self-asserted attributes. Most on-line communities today trust their users to tell the truth about themselves—i.e., to self-assert accurate data about themselves. Yet, many users self-assert false information. For instance, sexual predators sometimes pretend to be minors to gain their intended victims' confidence. To limit such misrepresentations, the present invention uses the following logic:
1. In the absence of age verification, any user can lie about his or her age (or other attribute). Thus, users' self-asserted ages (or other attributes) cannot be assumed as accurate.
2. A typical user is connected with people on-line who know him/her off-line—physical-world friends and colleagues. These-people know something about the user's real age (or other subject attributes).
3. if such people verify that the user is telling the truth about his/her age/attribute (vouching for the user), even outsiders (i.e., strangers) can have greater confidence in the user's self-asserted age/attribute.
4. Users verified by many other users can be trusted more than users verified by few other users.
5. Users verified by other users who themselves have been verified can be trusted to an even greater extent; they are verified by others known to be trustworthy.

As indicated, age is only one of several socio-demographic attributes verifiable through this logic. Gender, marital status and geographic location can be verified in much the same way. The present invention provides an easy-to-interpret score representing the likelihood that a user is self-asserting his actual age or other attribute. These scores are computed by an algorithm based on social network analysis. Thus, the present invention enhances the identity oracle concept, by providing not only users' self-asserted ages, but also its degree of confidence in this data.

The same approach has many applications. For example, it can limit/prevent minors from accessing inappropriate web content. When an on-line user applies to enter an adult-only website, the site may query the identity oracle about the user's age. If the identity oracle is reasonably sure that the user is 18 or over (21 in some jurisdictions), the site grants user access. The identity oracle can also reduce online harassment and bullying using a similar approach. Cyber-bullies gain much of their power by misrepresenting themselves online. If online communities validate users' self-asserted attributes (e.g., age, gender, etc.) using the facilities of the identity oracle, bullies will find it much more difficult to misrepresent themselves. Thus, the present system provides its users information about each other, empowering them to make more accurate trust judgments (i.e., judgments concerning each other's trustworthiness).

Before proceeding, it is useful to precisely define the problem space within which the present invention finds application and create a concise vocabulary for concepts used throughout the remainder of this discussion. As we observed above, in a typical interaction or transaction one user must take a leap of faith: making himself vulnerable to the other user (for instance, by pre-paying for an as-yet-undelivered laptop computer). When neither user trusts his/her counterparty enough to make this leap of faith, interactions/transactions fail to take place. Conversely, trust abuses occur when one user takes the leap of faith, and the counterparty.

The present systems and methods alleviate these problems by providing a more accurate basis for trust judgments about its users. Users can make more accurate trust judgments when they have reliable information about each other's socio-demographic attributes. This has two consequences. On one hand, parties to a transaction have more confidence in each other's trustworthiness. Interactions become less risky in general, and, consequently, become more frequent. On the other hand, spoofers (e.g., those intending to not honor promises and/or deceive other users) have less ability to hide behind Internet anonymity. Users can avoid spoofers more easily, decreasing opportunities for misplaced trust.

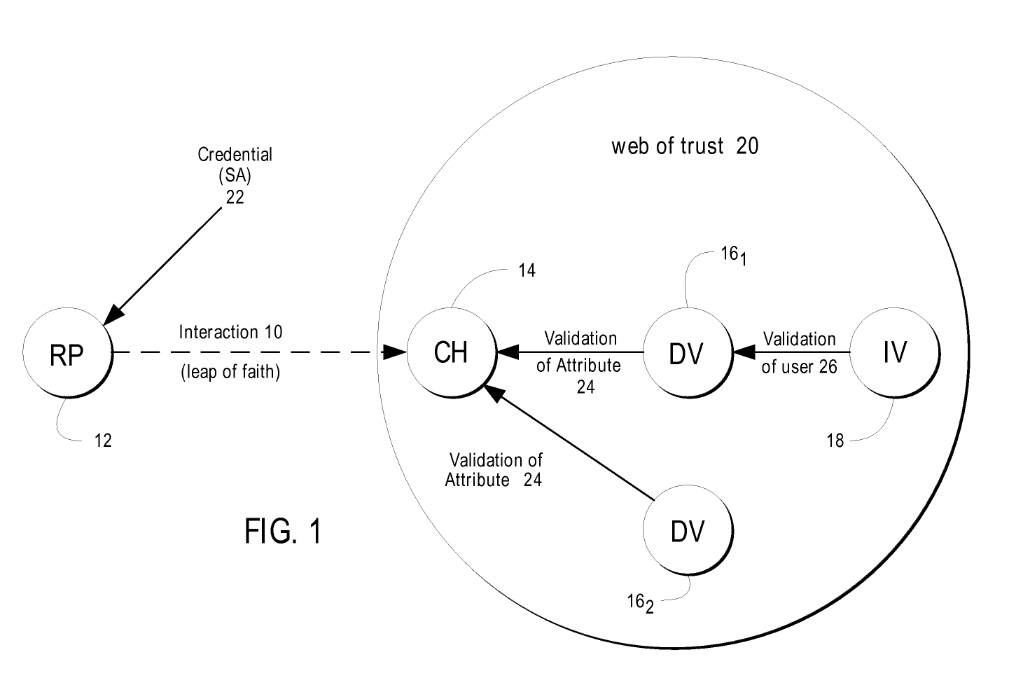

Referring now to FIG. 1, we introduce the participants of an interaction/transaction and their relationship to one another. In the present discussion, the user who takes a leap of faith in a transaction or interaction 10 is labeled a relying party (RP) 12 because s/he relies on the present system to provide accurate information about a counterparty. This RP receives a system-issued credential 22 indicating a confidence that the other party to the transaction or interaction, a credential holder (CH) 14, is not self-asserting false socio-demographic attributes. Each RP may him/herself be a CH.

In this context, the “system” may, in one embodiment, be an identity oracle fashioned in the manner described above. More generally, such a “system” may be an on-line (e.g., Web-based) service configured to provide verified, self-asserted information about its users or confidence scores indicative of a level of certainty or confidence that certain user-asserted attributes are true. By Web-based, we mean a service hosted at a computer-based resource accessible via a computer network (or network of networks) through convention tools such as an Internet browser.

For any given user, the system generates a credential by examining how that user is embedded in the system's web-of-trust 20: a social network of registered users who have verified each other's attributes. In other words, the system generates a credential for a specific attribute self-asserted by the subject CH by examining which other users validate that attribute (i.e., vouch for the CH's veracity). Such users are called direct validators (DV) 16₁, 16₂.

A user may be a DV in the context of one interaction, but be a CH in another interaction. Thus, DVs may have received validations of their own. In the context of the original interaction, the users who have validated DV attributes become validators-of-validators for the CH. Such users are labeled indirect validators (IV) 18.

As will become more apparent from the discussion below, in the present methods and systems users do not directly assess each other's trustworthiness, but end up doing so indirectly, to the extent that they trust each other to self-assert true identity attributes. Consider user A, who validates another user B's attributes. By doing so, A is indicating his belief that B is telling the truth. This says something about B's trustworthiness as a user. Thus, attribute validations serve as a proxy for user validations. Moreover, as users validate each other's attributes, they build a network of implicit user-level validations. Users who are more “entangled” in this network can be trusted more than their less-entangled peers because they have been verified by many users—who themselves have been verified by still other users. This builds on sociological research finding that: (1) human beings are “embedded” (i.e., entangled) in webs of social relationships; (2) the way they are entangled (i.e., embedded) affects their behaviors; and (3) with greater embeddedness in a social network, people are less likely deceive and/or cheat other members of that network. The final point speaks to an important consideration: greater embeddedness indicates greater trustworthiness. This is explored further below.

A. Differentiating Between User- and Attribute-Validations

In the context of a specified interaction, DVs validate CH attributes (24), while IVs validate DVs as users (26). On one hand, users do not validate other users, but rather validate their attributes. A CH self-asserts many different attributes. A given DV may know about one CH attribute, but lack information about others. Thus, that DV may validate some of the CH's attributes, but not others. Thus, DVs validate attributes, not the CH as a whole user.

The most salient aspect of social relationships is trust; nearly all social network analyses implicitly analyze trust between individuals. The present system uses attribute validations as a proxy for trust between its users. Although trust constitutes the core of a social relationship, academic analysts seldom analyze trust relationships themselves; it is nearly impossible to collect data on trust itself. Data (users validating other users' attributes) translates to interpersonal trust in a straightforward manner. If user A validates another user B, A can be assumed to trust B to the extent that A believes that B is self-asserting true attributes. Thus, A's validation of B's attributes says something about A's trust in B as an individual. Accordingly, the present system uses attribute-level validations as a useful proxy for user-level trust relationships, a major component in its analyses.

The strength of these inter-user relationships is a closely related issue. Some relationships are stronger than others; for instance, friendships are generally stronger than acquaintances. The number of attribute-level validations can, therefore, represent a straightforward proxy. The more information two people know about each other, and the greater the number attributes they are willing to verify about each other, the more likely that they share greater trust. For instance, consider that if a user A validates six of another user B's attributes, the A-B relationship is likely stronger than another relationship between users C and D, where C validates only four of D's attributes.

Trust is dichotomized at a “strong acquaintance” level (people who know each other and have spent a little time together, but are not necessarily friends). This level is meaningful because it includes everyone who really knows the person, while at the same time excluding others who may have met the person a few times yet lack a meaningful social relationship. Thus, this threshold captures everyone in a network who has reliable data about an individual, but excludes others who have incomplete or potentially incorrect information. For these reasons, in one embodiment of the present invention one user (A) will be considered to have validated another (B) if A has validated a complete “basket” of B's basic attributes. This basic basket of attributes may include attributes that tend to include information known among people that share a meaningful relationship, for example a user's name, address, gender and birth date (age). Stated differently, the basket of attributes may include only those attributes that anyone who knows a user in any meaningful way should know. Other attributes (e.g., a current job, a place of birth, etc.) are excluded because it is possible to know people in a substantially meaningful way without knowing these attributes. Once A has validated every one of B's attributes in the basic basket of attributes, A can validate more esoteric attributes.

These explanations provide a basis for answering the question posed above: why DVs validate CH attributes while IVs validate DVs (as users). DVs know the CH directly, and have a basis for personally validating the CH's attributes. In contrast, IVs have no such relationship with the CH (by definition). Thus, the only way they contribute towards assessing the CH's trustworthiness is by (1) validating DVs; (2) making them more trustworthy (i.e., raising their SU scores (see below)); and (3) allowing them to validate the CH's attributes with greater weight. Thus, IV validations are necessarily filtered through the IV-DV relationship.

The present system differentiates attribute- and user-level validations. It issues an attribute score (SA) as a credential indicating a degree of confidence in a subject CH attribute. SA is returned to all users who query the system regarding the relevant CH attribute. In contrast, the system uses the user score (SU) when computing SA (discussed below). In one embodiment of the invention, for the attributes in the basic basket, SA=SU, because all basic attributes receive the verifications from the same people.

As illustrated diagrammatically in FIG. 1, when the RP queries the system about CH's attributes, the system returns its estimate how likely these attributes are to be true. To compute this estimate, the system examines the web of trust that the CH is embedded within, in addition to non-network signals of attribute truthfulness.

More precisely, the system will measure CH's embeddedness in the system's web of trust (along with other relevant signals), and return the results to the RP, packaged as a credential. In one embodiment of the invention, a social network analysis (SNA)-based algorithm is used to generate an accurate quantification of identity trust from the network of self-asserted attributes. This following discussion introduces the principles behind such a process and builds an example of the process from these principles.

B. Embeddedness and Egocentrism

The system measures a CH's embeddedness in social networks. This concept refers to human beings' “entanglement” in webs of ongoing social relationships. In general, human beings are entangled in webs of social relationships (i.e., social networks); the way they are entangled (i.e., embedded/dis-embedded) affects their behaviors; and with greater embeddedness in a social network, people are less likely deceive and/or cheat other members of that network. Since greater embeddedness indicates greater trustworthiness, the present system quantitatively measures a CH's degree of embeddedness.

Compared with their less-embedded peers, highly-embedded CHs (ones that are more difficult to dis-embed) have two characteristics: (1) They are verified (trusted) by a greater number of DVs; (2) who in turn are each verified (trusted) by a greater number of IVs. A CH's degree of embeddedness can be related to the CH's centrality. Measures for centrality come in several different varieties, each oriented to different objectives.

Local centrality measures a user's embeddedness within the individual's local network (radiating out from the individual), while global centrality measures a user's embeddedness within a network as a whole. For purposes of the present invention, local centrality measures are more relevant than global centrality measures, primarily because trust degrades quickly over social distance. For instance, most people trust their friends, and tend to trust friends-of-friends. However, they tend not to trust friends-of-friends-of-friends—people who are so distant that they are practically strangers. Thus, socially-distant people do not contribute much towards a CH's trustworthiness. In other words, it is a CH's embeddedness in a local web of trust that really matters, not his/her embeddedness in the larger web. This is also consistent with a usability requirement of a system such as that being presently proposed: The goal is to obtain a certain level of usable trust without imposing significant friction on the user, as security systems are not usually the primary goal of a user, they are, however, necessary to permit safe interactions in a social or entertainment network.

Local centrality measures come in two varieties. Degree centrality counts the number of individuals who are connected to the focal individual; similarly, indegree centrality counts the number of individuals who are “pointing at” the focal individual. Bonacich centrality layers greater sophistication on top of degree centrality.

In particular, Bonacich centrality is a function of a focal individual's number of connections, with each connection weighted by the value of its connections. in other words, a focal individual gains greater Bonacich centrality by connecting with well-connected vs. relatively isolated individuals. In mathematical terms, the local centrality of node i in a social network (graph) with j connections is calculated by:

$${C}_{i} = {\sum }_{j}^{ } {r}_{ij} ( α + β {C}_{j} )$$

where Cᵢ is the centrality of node i, rᵢⱼ is the (quantified) strength of the connection between individuals i and j, and Cⱼ is the centrality of node j. α is an arbitrary standardizing constant ensuring that the final centrality scores will vary around a mean value of 1. In contrast, β has more substantial significance; it indicates how much Cⱼ, should contribute towards Cᵢ. β=1 indicates that the full value of Cⱼ is added to Cᵢ; in contrast, β=0 indicates that the Cⱼ does not affect Cᵢ at all. Where rᵢⱼ and α both=1 and β=0, the equation for Bonacich centrality reduces to the equation for (un-normalized) degree centrality.

In various embodiments of the present system, degree centrality becomes the size of a focal individual's immediate social circle. It shows how large the CH's immediate circle of trust is, and therefore, how trustworthy the CH is likely to be. Indegree centrality is even more useful; it becomes a count of users (DVs) that validate (“point towards”) the CH. These measures usefully illustrate the CH's embeddedness in an immediately local network.

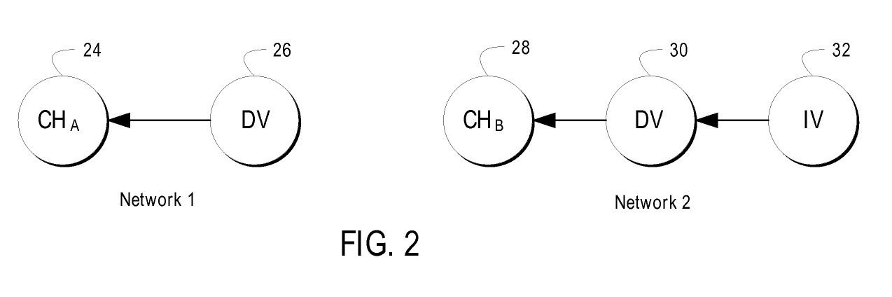

According to another embodiment of the invention, a version of Bonacich centrality that counts only incoming connections (indegree Bonacich centrality) may be used. This measure starts with indegree centrality, but radiates out further in the network. To understand this, consider the example of two different networks shown in FIG. 2. Here two CHs (CH_{A} 24 in network 1 and CH_{B} 28 in network 2) each receive a single DV validation. However, CH_{B} is validated by a DV 30 receiving an IV 32 verification, while CH_{A} is validated by a DV 26 that lacks any IV validation. Here, CH_{B} is more embedded in his local network than CH_{A} is in her local network. Unlike indegree degree centrality, indegree Bonacich centrality accounts for such differences. rᵢⱼ is constant for all verifications.

To better understand the above, consider that if if rij=1, α=1 (not standardized), and β=0.5, then C_{A}=1 and C_{B}=1.5, as follows:

$$\begin{matrix}For {CH}_{A} \text{:} {C}_{A} = {r}_{ij} ( α + β * {C}_{DV 26} ) \\ = ( 1 ) ( 1 + 0.5 * 0 ) ; {C}_{DV 26} \\ = 0 because DV 26 is not verified by any IV . \\ = 1\end{matrix}$$

$$\begin{matrix}For {CH}_{B} \text{:} {C}_{B} = {r}_{ij} ( α + β * {C}_{DV 30} ) \\ = ( 1 ) ( 1 + 0.5 * 1 ) ; {C}_{DV 30} \\ = {r}_{ij} ( α + β * {C}_{IV 32} ) \\ = ( 1 ) ( 1 + 0.5 * 0 ) \\ = 1 \\ = 1.5\end{matrix}$$

There are no cycles (i.e., loops in the social network graph), so centrality scores for each network are computed in a single iteration.

Indegree Bonacich centrality not only measures a CH's entanglement in his/her immediately local (DV) and slightly-removed (IV) networks, but also matches intuitively with the butterfly-in-a-web metaphor (it takes fewer cuts to remove a butterfly entangled in a remote part of a spider's web than it does to remove a butterfly entangled near the center of a web). Consequently, indegree Bonacich centrality represents a substantively meaningful measure of a CH's embeddedness into his/her local network; it appears to be a reasonable measure of embeddedness.

C. Relational Non-Redundancy

However, Bonacich centrality is not a perfect solution. For example, this measure does not account for the way redundancy affects trustworthiness. Redundancy, in this context, refers to the existence of multiple chains of relationships (paths) connecting two individuals in a social network. Individuals who are connected with a greater number of unique (non-overlapping) paths are more difficult to disconnect from each other. For instance, consider two individuals connected through seven unique paths. To cut information flows between these individuals, one would have to sever seven distinct communication channels. In contrast, two individuals connected through a single unique path could be disconnected by severing that one communication path.

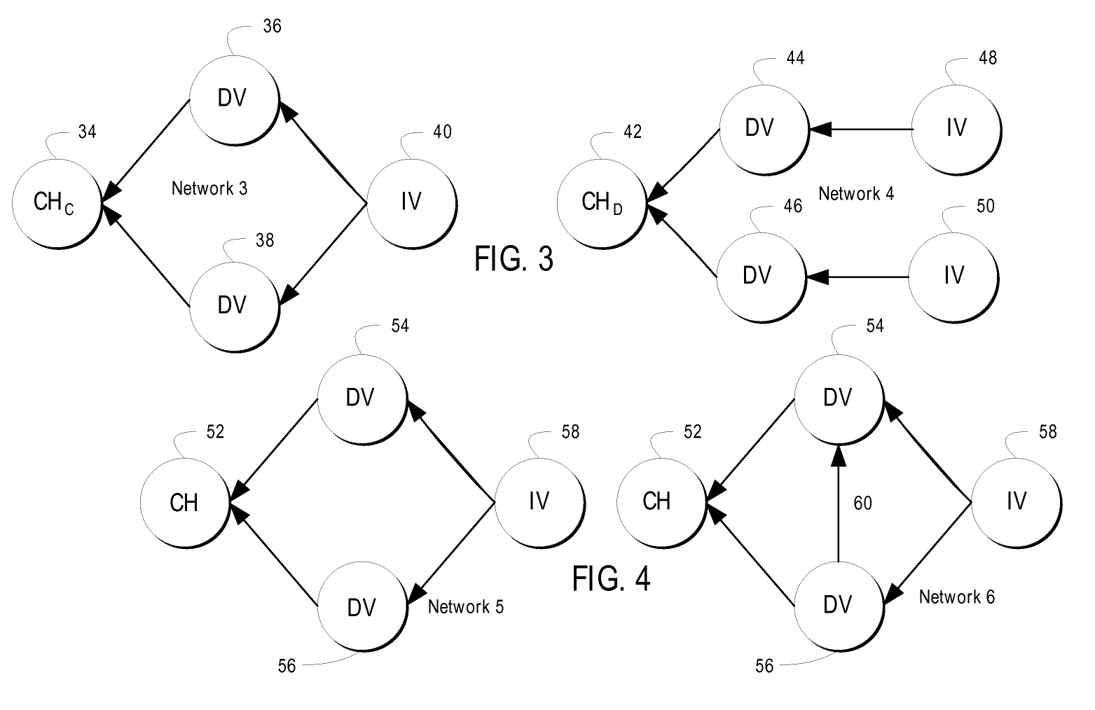

A social network can be considered “more redundant” if it contains a higher proportion of redundant paths compared to a “less redundant” network. Egocentric social networks range between two extremes: complete redundancy (where everyone is connected with each other) versus complete non-redundancy (where no redundant paths exist). People face a trade-off between these extremes. Why? At any given time, a person can only maintain a finite number of social relationships; each relationship takes time to maintain, and people have a finite amount of time. Given this situation, a person has choices ranging between the two extremes: to maintain relationships with a closely-knit group of friends who all know each other—illustrated diagrammatically as CH_{C} 34 of network 3 in FIG. 3,—or to share relationships with a widely dispersed group of individuals that do not know each other—illustrated diagrammatically as CH_{D} 42 of network 4.

Which network, 3 or 4, is more advantageous? The answer depends on the situation. For many purposes (e.g., building a community), network 3 is more advantageous. However, for the purpose of obtaining unique information (i.e., networking to find a job), network 4 is advantageous. Individuals who do not know each other more likely obtain information from different sources, and the information they provide is more likely to be diverse. In contrast, information that originates within a close-knit group of people is likely to spread quickly within that network, crowding out other relevant pieces of information. Thus, the focal individual CH_{C} 34 of network 3 is likely to receive the same (redundant) information from many different people; for instance, s/he might find out about the same job opening from several of his friends (who all know each other). In contrast, CH_{D} 42 of network 4 is likely to receive different (non-redundant) information from many different people; for instance, s/he might learn about several different job openings.

For the situations depicted in FIG. 3, CH_{C} 34 is verified by two different people, DVs 36 and 38, each of whom are verified by a single IV 40. CH_{D} 42 is also verified by 2 different people, DVs 44 and 46, but these two individuals are each verified by a different IV, 48 and 50, respectively. If we again assume that rᵢⱼ=1 for all verifications; α=1 (not standardized); and β=0.5, then the focal individuals CH_{C} 34 and CH_{D} 42 will have the same centrality scores:

$$\begin{matrix}For {CH}_{C} \text{:} {C}_{C} = {r}_{ij} [ ( α + β * {C}_{DV 36} ) + ( α + β * {C}_{DV 38} ) ] \\ = ( 1 ) [ \begin{matrix}( 1 + 0.5 * {r}_{ij} ( α + β * {C}_{IV 40} ) ) + \\ ( 1 + 0.5 * {r}_{ij} ( α + β * {C}_{IV 40} ) )\end{matrix} ] \\ = ( 1 ) [ \begin{matrix}( 1 + 0.5 * 1 ( 1 + 0.5 * 0 ) ) + \\ ( 1 + 0.5 * 1 ( 1 + 0.5 * 0 ) )\end{matrix} ] \\ = 1 [ 1.5 + 1.5 ] \\ = 3\end{matrix}$$

$$\begin{matrix}For {CH}_{D} \text{:} {C}_{D} = {r}_{ij} [ ( α + β * {C}_{DV 44} ) + ( α + β * {C}_{DV 46} ) ] \\ = ( 1 ) [ \begin{matrix}( 1 + 0.5 * {r}_{ij} ( α + β * {C}_{IV 48} ) ) + \\ ( 1 + 0.5 * {r}_{ij} ( α + β * {C}_{IV 50} ) )\end{matrix} ] \\ = ( 1 ) [ \begin{matrix}( 1 + 0.5 * 1 ( 1 + 0.5 * 0 ) ) + \\ ( 1 + 0.5 * 1 ( 1 + 0.5 * 0 ) )\end{matrix} ] \\ = 1 [ 1.5 + 1.5 ] \\ = 3\end{matrix}$$

Thus, although they are embedded in different ways in different networks, CH_{C} and CH_{D} have identical indegree Bonacich centrality scores. Nevertheless, the system is more confident that CH_{D} is not attempting to spoof the system. The more dispersed, less cohesive network (network 4) offers greater information non-redundancy. Information on CH_{C}'s trustworthiness comes from three individuals (directly from 2 DVs and indirectly from a single IV), while information on CH_{D}'s trustworthiness comes from four individuals (directly from 2 DVs and indirectly from two IVs). Everything else being equal, the system can have greater confidence in CH_{D}'s trustworthiness.

D. Network Closure

Another phenomenon (occurring in social networks) is also relevant. Network closure measures how closely-knit a network is. That is, the degree to which its members are connected to each other. The more closed (closely-knit) a network, the more connected its members are to each other. In FIG. 3, network 3 is has greater closure than network 4.

By definition, closure is closely related to information redundancy. Practically, if a network's members are highly connected with each other, their information sources are more likely to be redundant. Consequently, the greater a network's closure, the greater the information redundancy within that network.

Closure, however, also has more insidious consequences. Closure generates enforceable trust within a tightly-knit group. By definition, social groups with closure possess multiple, redundant information channels. Thus, information flows freely within the group, ensuring that everyone “in the loop” knows everything about everyone else. This spread of rumors has three converging effects. Since group members know a great deal about each other, they know what to expect from each other. Additionally, members quickly find out about people who violate social norms, and get each other to collectively punish these violators. Most importantly, members develop a collective sense of affection for the group and its members. Taken together, tightly-knit groups (with network closure) acquire substantial potential for collective action. Such enforceable trust is particularly powerful for mobilizing groups against outsiders, including authority figures. For instance, police investigators often face great difficulty investigating incidents that happen inside closed communities (e.g., cults and small ethnic groups).

A small, tightly-knit group of friends has greater capacity to spoor the system than an equal number of people who do not know each other. For instance, suppose a married man decides that he desires other women on the side. Ordinarily, on on-line dating sites, the system would mark him as a married man and hinder his efforts. But, if the man convinces four friends to vouch for the (false) fact that he is single, then he may defeat the safeguards offered by the system. In a tightly knit group it is likely that his friends would comply with this request, not only because they want to help their friend, but also because they fear social retribution from the others in the group. Here, the system is an outsider to this group and is a prime target when it gets in the group's way.

Recognizing this potential for fraud, in embodiments of the present invention the system guards against such events by penalizing CHs who have highly-closed, egocentric networks. In other words, the greater a CH's apparent ability to spoof the system, the less confidence the system must have in that individual's self-assertions. While a majority of people that belong to closely-knit groups of friends may have no incentives to self-assert false attributes, the system is configured to penalize them based on their capacity (not necessarily their intention) to spoof.

But this presents a problem for systems that rely on indegree Bonacich centrality, which rewards closure instead of penalizing it. For instance, consider FIG. 4: networks 5 and 6 are identical, with a CH 52 being verified by two DVs 54 and 56, each verified by a common IV 58, except for a single DV-to-DV verification 60, present in network 6. If the two DVs 54 and 56 and the CH 52 all know each other, they are more likely to represent something like the group of friends in the above example. Thus, the system should have reduced confidence in CH 52 for the network 6 situation compared with the situation in network 5. However, indegree Bonacich centrality is higher for the network 6 case:

$$\begin{matrix}For network 5 \text{:} {C}_{CH} = {r}_{ij} [ ( α + β * {C}_{DV 54} ) + ( α + β * {C}_{DV 56} ) ] \\ = ( 1 ) [ \begin{matrix}( 1 + 0.5 * {r}_{ij} ( α + β * {C}_{IV 58} ) ) + \\ ( 1 + 0.5 * {r}_{ij} ( α + β * {C}_{IV 58} ) )\end{matrix} ] \\ = ( 1 ) [ \begin{matrix}( 1 + 0.5 * 1 ( 1 + 0.5 * 0 ) ) + \\ ( 1 + 0.5 * 1 ( 1 + 0.5 * 0 ) )\end{matrix} ] \\ = 1 [ 1.5 + 1.5 ] \\ = 3\end{matrix}$$

$$\begin{matrix}For network 6 \text{:} {C}_{CH} = {r}_{ij} [ ( α + β * {C}_{DV 54} ) + ( α + β * {C}_{DV 56} ) ] \\ = ( 1 ) [ \begin{matrix}( 1 + 0.5 * {r}_{ij} \{ ( α + β * {C}_{IV 48} ) + \\ ( α + β * {C}_{DV 56} ) \} + \\ ( 1 + 0.5 * {r}_{ij} ( α + β * {C}_{IV 50} ) )\end{matrix} ] \\ = ( 1 ) [ \begin{matrix}( 1 + 0.5 * 1 \{ ( 1 + 0.5 * 0 ) + \\ ( 1 + 0.5 * ( 1 ) ( 1 + 0.5 * 0 ) ) \} + \\ ( 1 + 0.5 * 1 ( 1 + 0.5 * 0 ) )\end{matrix} ] \\ = 1 [ 1 + 0.5 ( 1 + 1.5 ) + 1.5 ] \\ = 1 [ 1 + 1.25 + 1.5 ] \\ = 3.75\end{matrix}$$

One solution for this dilemma is to follow the spirit of indegree Bonacich centrality by accounting for network redundancy and closure. A score is generated based on a focal individual's immediate neighbors in a social network while addressing redundancy and closure.

Various embodiments of the present invention, however, adopt a different approach. This solution disaggregates the impacts of direct (DV) and indirect (IV) verification, and, taking advantage of this disaggregation, incorporates mechanisms for rewarding CHs for greater local network non-redundancy and penalizing local network closure. This solution has two primary components: direct embeddedness and indirect embeddedness.

E. Direct Embeddedness

Direct embeddedness refers to DVs' contribution towards the system's confidence in a given CH attribute (SA). DV effects on SA have a strong resemblance to indegree Bonacich centrality. Each DV verifying a CH attribute contributes a fraction (e.g., one-tenth) of his/her user score (SU) to the attribute's SA. This is equivalent to indegree Bonacich centrality where β=0.1, α=0 and rᵢⱼ=1.

Unlike indegree Bonacich centrality, direct embeddedness adjusts for closure. If any specified DV is verified by (or verifies) another DV, these two DVs' direct embeddedness contribution to SA is divided by 1.0. This adjustment accounts for the potential that the two DVs could collaborate with the CH to help him/her spoof the system. Consequently, the total direct embeddedness contribution to SA equals:

$${SA}_{i} ( DE ) = {\sum }_{j}^{ } ( β * {SU}_{j} / r )$$

Where SAᵢ(DE)=the direct embeddedness contribution towards an attribute of the i^{th} CH, β=0.1, SUⱼ=the SU value for the j^{th} DV verifying the relevant CH attribute, r=1.0 if the j^{th} DV verifies (or is verified by) another DV, and j=total number of DVs verifying the CH.

F. Indirect Embeddedness

Indirect embeddedness refers to IVs' contribution towards the system's confidence in a given CH attribute (SA). IV effects on SA also resemble indegree Bonacich centrality, but with a crucial difference: IVs are two degrees of separation removed from the CH, not one (like indegree Bonacich centrality and direct embeddedness). Each IV verifying a DV contributes a small fraction (e.g., 1/40^{th}) of his/her user score (SU) to a CH attribute's SA. This resembles indegree Bonacich centrality where β=0.025, α=0 and rᵢⱼ=1. However, it is important to note that j represents the set of all IVs, not DVs.

Indirect embeddedness adjusts for redundancy by limiting the total indirect embeddedness contribution per DV. Each DV (except for those that lack IVs altogether) links IVs with the CH. The IVs “belonging” to any single DV contributes a maximum number (e.g., 2) of points to SA. For instance, consider 10 IVs (each with SU=50) that are connected with a CH through a single DV. Each IV contributes 1/40×50=1.25 points to SA, for a total of 12.5 points. However, the IVs belonging to a single DV can only contribute a number of points up to the threshold value (2 in this example), so the total contribution to the subject CH's SA is capped at that threshold (2). This reflects the intent that a single DV's local network should not have undue influence on the CH's overall SA scores. Without this cap, a CH could elevate his/her SA scores by being verified by a single DV with a large number of IVs. This would violate a need to privilege non-redundant sources of information about CH trustworthiness.

Similarly, indirect embeddedness adjusts for redundancy by not double-counting IVs that verify two (or more) different DVs. When a single IV verifies multiple DVs, the SU score for such IVs contribute towards CH SA scores through multiple channels, one for each DV that the IV verifies. Considering that these channels are redundant and provide the system redundant information about the CH's trustworthiness, these channels should not be double-counted. To prevent double-counting, an IV's SU score is divided by the number of DVs that the IV verifies.

Indirect embeddedness, consequently, is calculated in a multistage process. For each IV, its contribution to SA is calculated by: (1) taking the IV's SU score, and dividing by a fraction (e.g., 40) and (2) dividing the result by the number of DVs the IV verifies. This creates several “score fragments” that are each (3) added to CH SA scores, (4) conditional on that particular DV's IVs contributing a total number of fragments that do not collectively exceed a threshold (e.g., the 2-point cap discussed above). For instance, an IV with SU=40 that verifies four different DVs contributes (1140×40)/4=0.25 points through four different channels. Each channel is subject to the 2 point cap. If one of these channels has already exceeded that cap, only three channels (each worth 0.25 points) actually contribute to the relevant CH SA score, for a total of 0.75 points. By making sure that IVs arc not double-counted-in calculations, this safeguard rewards CHs whose local networks have a high degree of non-redundancy.

Overall, the total indirect embeddedness contribution to SU can be expressed as:

$${SA}_{i} ( IE ) = {\sum }_{j}^{ } ( max ( {\sum }_{k}^{ } γ * f ( {SU}_{k} ) , 2 )$$

Where SAᵢ(IE)=the indirect embeddedness contribution towards the i^{th} CH; j=the number of DVs; k=the number of IVs associated with the j^{th} DV; γ=0.025; f(SUₖ)=the SU value for the k^{th} IV associated with the j^{th} DV, divided by the number of different DVs k is associated with.

G. Embeddedness and Threats

The present system identifies threats who are trying to spoof the system (i.e., self-assert false attributes). It provides its users opportunities to report other users who are self-asserting false attributes in two different situations:

Request to Validate False Attributes: Consider a situation where user A asks user B to validate an attribute that B knows to be false. B can validate the attribute as requested, compromising the system's integrity. Conversely, B can report A for A's attempt to self-asserting false attributes. The “self-regulation through social norms model” is appropriate here.

Of course, not all users in B's situation will report A's false self-assertions. Users who are connected by a large number of redundant paths (i.e., members of a tightly-knit group with high closure) are likely to lie for each other; such users will validate (rather than report) false self-assertions.

Unlike highly closed networks, networks with low closure work to the present system's advantage. Individuals who know each other but are not connected through redundant paths have the ability to report each other. They have no friends in common. Consequently, they are not members of the same tightly-knit group, and need not worry about the consequences of violating enforceable trust. Thus, assuming that users of the present system have a desire to defend against intruders, such users have the knowledge and motivation to report false self-assertions.

H. Embeddedness in Other Social Networks

The present system is configured to award greater confidence for CHs embedded in other, on-line social networks (i.e., social networks other than the web of trust created by the present system). This is based on a recognition that a CH who is highly embedded in such other networks is more likely to be trustworthy than someone who is not. However, not all social networks are treated equally.

Relationships in some on-line social networks provide greater trustworthiness than relationships in other networks. Two mechanisms differentiate different networks. First, some networks scrutinize their users' asserted attributes more than other networks. For instance, some social networks validate their users' school and/or business affiliations by requiring e-mail addresses from the appropriate .edu and/or .com domains. Thus, within such a network a user cannot self-assert himself/herself as a student of a particular institution without a corresponding e-mail address from that institution. Also, some social networks offer categorization of contacts within their networks and include (optional) mutual-confirmation, so that someone claiming to be colleague from a particular company must be confirmed by the user before he/she is permitted to self-assert that affiliation within his/her user profile. Networks that adopt such measures are more secure than networks lacking such mechanisms, hence data obtained from such networks is deemed to be more reliable than similar information obtained from other social networks.

It is also true that some social networks embody deeper social ties than others, based on the network's culture and purpose. For instance, some social networks are intended to provide career-related networking opportunities, while others are intended for entertainment purposes. Assuming that people are more likely to engage in frivolous activities for entertainment than career-related purposes, those networks intended for the career-related purposes are deemed to provide relationship information that is more likely to be meaningful than relationship data obtained from social networks intended primarily for entertainment purposes. This distinction can be realized through weighting factors.

Therefore, in various embodiments of the invention, credential scores receive contributions for an individual's embeddedness in social networks other than the system's web of trust, and these contributions may be based on the nature of the other social network in which the individual is involved and the number (and perhaps type) of connections the individual has within those networks. The total contribution for such embeddedness to the individuals overall SA may be capped (i.e., weighted).

I. Identity Measures

Social network analysis (SNA) measures for embeddedness (such as those discussed above) represent powerful ways to predict CH attributes' truthfulness. However, other techniques represent useful complements to SNA-based analyses. Non-SNA validation techniques (identity measures) focus on three aspects of self-assertions:
1. User profiles having a greater number of meaningfully-completed attributes (e.g., name, address, photo, multiple distinct e-mail addresses, etc.) require greater time and effort to create.
2. Users who provide difficult-to-replicate attributes or features (e.g., social network profiles with a long, consistent history of activity) cannot re-use the same attributes to create additional (fake) profiles.
3. Users who have existing profiles on certain trusted profile sites (such as the career-oriented social network sites discussed above). The principle here is that if someone has a profile on such a site and possesses contacts of a significant quantity, the present system can trust the self-assertions of this virtual person to a greater extent versus someone who does not have such an affiliation.

In other words, user profiles requiring greater effort to create, that include nonreplicable attributes and leverage other “trusted” profiles, more likely contain truthful self-assertions than profiles lacking sonic or all of these features. Consequently, the present system's identity measures assign higher confidence (SA) to attributes belonging to CHs who self-assert (1) greater amounts of (2) difficult-to-generate attributes. At the same time, it is recognized that many, if not most, identity measures are easily self-asserted by strategic, determined individuals intent of spooling; consequently, the present system weights scores obtained through such identity measures relative to scores developed through network analysis.

J. Trusted Anchors

The trusted anchor process is another useful complement to SNA-based analyses. Various entities maintain vast amounts of data concerning individuals. For instance, credit rating agencies not only possess information on peoples' financial positions, but also their socio-demographic attributes. The present system validates trusted anchors' self-asserted attributes against their credit reports or information obtained from similar, trusted databases (preferably on-line databases) or requires an in-person proofing of those attributes.

The trusted anchor process is less optimal than SNA processes for two reasons. First, this process involves additional “friction” for users. Document review, on-line form verification and in-person processing all create additional work for users. Second, validating users against on-line databases usually involves monetary costs. Credit agencies (and other database owners) typically will not allow access their data for free. Furthermore, many of these databases do not provide global, all-ages coverage, which makes them less than optimal sources of information. Even if these databases are aggregated, they often contain inaccurate data which makes matching only partially automated, and often requires human-based exception handling at much higher costs. In contrast, SNA-based validation involves neither of these costs; thus, SNA may be preferable.

Yet, the trusted anchor process represents an ideal complement to SNA-based techniques. Some users may be isolates having little or no connection with the web of trust. The trusted anchor process gives these users an opportunity to validate their attributes at a much higher confidence level. Additionally, the trusted anchor process is useful for double-checking CH attributes in two situations: (1) when a CH attribute's veracity is challenged by other users; and (2) random spot-checks of members. Although the trusted anchor process is not a suitable replacement for the web of trust, it represents an excellent complement.

Trusted anchors may be granted powerful responsibilities within the present system. Through direct embeddedness, trusted anchors can influence other users' scores dramatically. Since they are given extremely high SU scores (above those which can be achieved by other users), trusted anchors contribute dramatically to SA scores for user attributes they verify. Consequently, they are implicitly made responsible for the trustworthiness of their local network as a whole. Trusted anchors also provide a powerful method to “seed” the network with highly trustworthy individuals who can then propagate their trust into the network.

K. Institution of Trust

The present system is imbibed with features that create strong social norms against users self-asserting false attributes. In many respects, this principle strongly resembles the self-regulation through social norms model. However, the principle differs from its predecessor in two important ways: it is backed with (1) verification algorithms and (2) legal consequences. In other words, the system creates an enforceable version of the self-regulation through social norms model.
1. Individual vs. Group Rewards: A “conspiracy” to spoof the system may benefit a single user (e.g., a solitary sexual predator), or several different users colluding with each other (e.g., a ring of child molesters). This distinction structures potential participants' incentives in different ways. For instance, someone who is asked to “help a friend” cheat the system is likely to respond in different ways depending on the risk he/she will incur.
2. Punishment: A related question is the need for secrecy. On one hand, potential threats require secrecy because they aim at deceiving other users of the system. On the other hand, potential threats maintain secrecy because they fear punishment for their misdeeds.
   Together, these two dimensions constitute a 2×2 typology of potential threats, as shown in Table 1:

TABLE 1

| | | Benefits Accrue To: | |
|---|---|---|---|
| | | Individual | Group |
| Punishment | Severe | (1) Solitary: benefiting individual | (2) Conspiracy: potential beneficiaries |
| if Caught | | acts alone, as incentive structure | use “honor among thieves” (mutual |
| | | prevents him/her from enlisting | trust) to achieve shared malfeasance. |
| | | compatriots. | |
| | Negligible | (3) Help-a-Friend: benefiting | (4) Just-for-Fun: potential |
| | | individual enlists non-benefiting | beneficiaries enlist each other (and |
| | | compatriots (who have little to | non-participating friends) to achieve |
| | | lose). | shared malfeasance. |

Case 1 (Solitary Threats): Where (1) potential punishments arc severe, and (2) benefits accrue to single individuals, the threat is likely to consist of a single individual unable to enlist compatriots. The benefiting individual has the incentive to incur substantial risks. However, his friends (or other accomplices) have no reason to help him in the face of harsh potential punishments. Consequently, such threats are less dangerous than other types of threats (see below). For instance, a highly-motivated child molester might self-assert that he is an 11-year old. However, this assertion cannot obtain a high confidence score (SA) because the associated user cannot attempt to obtain verification of this (false) attribute by other users for fear of being reported by these other, who have no incentive to help him.

Case 2 (Conspiracy): Where (1) potential punishments arc severe, and (2) benefits accrue to multiple individuals, the threat is likely to consist of a group of closely-knit conspirators bound together by enforceable trust. Having preexisting, redundant social relationships, these conspirators have “honor among thieves”, i.e., the mutual trust required to cooperatively pursue illegal activities. Such threats are likely to resemble a child molester ring, where several molesters band together to represent one of their members as a minor. Conspiracies are likely to come in two varieties: unintelligent conspirators, who attempt to perpetrate frauds and are caught (e.g., on the basis of records maintained by the system), and intelligent conspirators, who recognize the risks and abandon attempts to spoof the system.

Case 3 (Help-A-Friend): Where (1) potential punishments are negligible, and (2) benefits accrue to a single individual, the threat is likely to consist of the benefiting individual and a group of his/her friends possessing high network closure. Without facing potential punishments, the threat's friends have an incentive to help their friend or face the collective wrath of the group (through enforceable trust). Although such threats are difficult to defend against, the stakes are considerably lower (assuming that punishments are correlated with the severity of a “crime”).

Case 4 (Just for Fun): Where (1) potential punishments are negligible, and (2) benefits accrue to a group, the threat is likely to consist of that group. Without facing potential punishments, this group has an incentive to collectively spoof the system that is not countered by fear of punishment. Like case 3, such threats are low-risk but difficult to defend against. For example, consider a group of 13-year old children self-asserting that they are 18, perhaps to get around something like an age-restriction at a certain web site. These individuals do not harm anyone (except perhaps themselves) by their fraud. Such threats are extremely likely to avoid spoofing behaviors, however, if they face consequential legal sanctions.

These above case scenarios illustrate the need to back up the on-line system with physical-world punishments, including but not limited to strict penalties for violations of terms of service. Abusers (including those who would falsely verify assertions of a CH) may also be deterred by conducting credit checks on all users, and performing random verifications of user information against credit reports. Through such a strategy, the system establishes and maintains a reputation for being intolerant of users who self-assert false attributes. Consequently, the system obtains the benefits of the “self-regulation through social norms model” and backs it with enforcement mechanisms. Through these measures, the system establishes itself as an institution of trust and at the same time reduces the number of false positive verifications occasioned by people verifying attributes without actual knowledge of the CH.

In addition, the present system may incorporate “user feedback” in the sense that users can report falsehoods which they uncover about others (e.g., invalid self-asserted ages, marital status, etc.). Following appropriate investigations and verifications of these inaccuracies, individuals responsible for the inaccurate assertions, including perhaps verifiers responsible for collusion or negligence, can be punished. As these investigations identify threat vectors, the system can be modified to eliminate same.

L. Computing a Credential Score

The present methods and systems thus involve a number of techniques for increasing trust between users as indicated in Table 2:

TABLE 2

| Mechanism | CH attribute validation through: |
|---|---|
| Direct Embeddedness* | Embeddedness in the system's |
| | web of trust (direct) |
| Indirect Embeddedness* | Embeddedness in the system's |
| | web of trust (indirect) |
| Embeddedness and | Reporting threats embedded in |
| Threats | the system's web of trust |
| Embeddedness in | Embeddedness in other social networks |
| Other Social Networks* | |
| Identity Measures* | Verification using non-network measures |
| Trusted Anchors* | Verification using existing (on-line) databases |
| Institution of Trust | Cultural/institutional construction and |
| | enforcement |

In various embodiments of the invention, some of these measures (marked with * in Table 2) are synthesized into a single SA score for a CH.

In some embodiments, the system's response to threats are not so synthesized into the SA score. Consider for example, a situation where one user reports another user's self-asserted attributes as false, but no definitive resolution of the assertion either way can be made using objectively verifiable data (e.g., from publicly available database sources). Under these circumstances, no objectively quantifiable demerits can be incorporated in the subject SA. Hence, the system reports demerits separately from the SA score, possibly with explanations of the dispute, allowing an RP to make an independent judgment of the situation. Over time, some of these situations may be verified through the trusted anchor process, allowing the demerits to be incorporated in the SA score (or eliminating them as false challenges).

Finally, the system exists as an institution of trust. Such an institution does not validate individual users' scores; rather, it enhances trustworthiness. Thus, it is not appropriate to incorporate this mechanism into SA score calculations.

In one embodiment of the invention, the single SA score is synthesized as follows: (1) each contributing mechanism from Table 2 is assigned a certain number of total points which it can contribute to an overall score (e.g., this amounts to a weighting factor); and (2) the actual points attributable to the individual mechanisms (up to their respective maximum point values) for a given CH's SA are added together. Thus, SA scores are calculated through a scoresheet approach, where each mechanism is allocated a specific number of scoresheet points and the SA scores are simply the summed total of these scoresheet points. An example of such a scoresheet is shown below in Table 3.

TABLE 3

| | | Maximum |
|---|---|---|
| Mechanism | Calculation | Points |
| Direct Embeddedness* | ${\sum }_{j} ( β * {SU}_{j} / r )$ | 10 |
| Indirect Embeddedness* | ${\sum }_{j} ( max ( {\sum }_{k} γ * f ( {SU}_{k} ) , 2 )$ | 30 |
| Embeddedness in Other | Threshold: | 5 |
| Social Networks* | If (# of contacts in other | |
| | network >20, 5, 0), etc. | |
| Identity Measures* | Baseline score (e.g., 10 points) | 5* |
| Trusted Anchors* | Baseline score (e.g.. 50 points) | 50 |
| Total | | 100 |

*identity measures substitute for embeddedness in other social networks, thus, this mechanism's points are not cumulative.

Any points generated by a mechanism in excess of the maximum number of its assigned scoresheet points are truncated (ignored).

This scoresheet has several noteworthy characteristics:
1. A user can reach 100 points maximum. However, to exceed 50 points, the user must become a trusted anchor.
2. Indirect embeddedness accounts for the majority (60%) of the remaining 50 points. To generate a large number of indirect embeddedness points, CHs must be connected with a large number of IVs. Assuming that potential spoofers will have difficulty creating a large number of fake profiles, the indirect embeddedness measure is exceedingly difficult to spoof. Consequently, it is given the greatest weight in the scoresheet.
3. Direct embeddedness accounts for a substantial proportion (30%) of these points. On one hand, CHs require several different DVs to generate many direct embeddedness points. On the other hand, the number of DVs required is low enough to be spoofed by an extremely dedicated spoofer. For instance, a spoofer might create 10 fake accounts, each with maximum identity measures (SU=10), that each validate an 11^{th} account that already has 10 identity points. Thus, the spoofer is able to create an account with 20 points. The reason that direct embeddedness points are capped at 15 is to prevent spoofers from reaching higher point values through this mechanism.
4. Embeddedness replaces identity measures whenever possible. In some networks, embeddedness is much more difficult to replicate than identity measures, which are strictly self-asserted.

According to another embodiment of the invention, SA scores are replaced with percentage likelihoods that a self-asserted attribute is actually true. In either instance, the SA score (or the likelihood determination) may be reported to an RP upon request. For example, the RP may be a web site intended for adults. When a user attempts to access the web site and reports his/her age and another identifier (e.g., an e-mail address), the web site may send a request to the system to report the SA for the subject individual's (identified by the e-mail address) age. Here, age would be the attribute under test and the SA for the age would be computed as the sum of the contributing mechanism scores. It would then be up to the subject web site to admit the user or deny entry (e.g., on the basis of whether or not the reported SA for the user's age met or exceeded a required threshold).

Thus, methods and systems for verifying on-line identities and, more particularly, attributes of such identities, using social network analysis and other means have been described. The examples presented in connection with this description were intended merely to illustrate aspects of the present invention, and should not be read as limiting the invention. For example, embodiments of the present invention find application in connection with micro-credit lending programs. It is known that many people in the Third World do not have established credit histories, at least not with well-known credit rating agencies which lenders look to for reports on credit worthiness. Thus, many micro-credit lending agencies, which have become popular among Internet users, arc having a hard time identifying creditworthy versus non-creditworthy individuals. The present invention can be used to alleviate this situation.

By replacing “confidence in identity attributes” by “confidence that someone will repay a loan,” the present invention provides a means for an individual to evaluate whether or not to extend credit (e.g., in the form of a loan) to another. Individuals without established credit histories can now be vouched for by other individuals who have established credit histories. The pattern of these verifications can be analyzed in the same manner as identity verifications discussed above. In such a scenario, the CH is the individual seeking credit (or a loan), DVs and IVs are individuals with established credit histories, and the RP is the putative lender. In some instances, the micro-lending instantiation may require some modifications to the above-described processes; for example, examining how a default would affect both the borrower and the individuals vouching for the borrower, and modifying the non-network analyses accordingly (e.g., by ascribing different weightings to same).

Further, from the above description, it should be apparent that various embodiments of the present invention may be implemented with the aid of computer-implemented processes or methods (a.k.a. programs or routines) that may be rendered in any computer language, stored on any tangible computer-readable medium, and executed by a computer processor in order to perform the intended functions described above. Where reference was made to algorithms and symbolic representations of operations on data, such operations may be made on data stored within a computer memory or other tangible computer-readable medium. These algorithmic descriptions and representations are the means used by those skilled in the computer science arts to most effectively convey the substance of their work to others skilled in the art. Thus, throughout the description of the present invention, use of terms such as “processing”, “computing”, “calculating”, “determining”, “displaying” or the like, were intended to refer to the action and processes of a computer system, or similar electronic computing device, suitably programmed to manipulate and transform data represented as physical (electronic) quantities within the computer system's registers and memories into other data similarly represented as physical quantities within the computer system memories or registers or other such information storage devices in order to implement the above described processes. Thus, such a computer system under these programming conditions is best viewed as an apparatus specially configured to implement the present methods.

An advantage of the computations of direct and indirect embeddedness discussed above, when instantiated as computer-implemented processes, is that they can be run in linear-time (i.e., n-time in Big-O notation) for most on-line social networks. In contrast, most social network-based algorithms do not run in linear time. Because the present computations run more quickly than n log n time, it is scalable to large-scale applications. To better appreciate this point, consider that an algorithm that runs in n² time may be run for 100 users without much difficulty. To run the same algorithm for 1000 users, however, 100 times the computing power is required because the computational needs increase exponentially. The same increase, from 100 to 1000 users, would only require a 10 time increase in computing power for a linear algorithm such as that provided by the present invention.

What is claimed is:

1. A computer-implemented method, comprising reporting, in response to receiving a request therefor, a credential that represents an estimate as to how likely a self-asserted attribute of an individual representing said attribute as true is in fact true, wherein the estimate is computed through a plurality of mechanisms, including an examination of a web of trust within which the individual is embedded and non-network analysis based measures of a veracity of the attribute's asserted value.

2. The method of claim 1, wherein the examination of the web of trust includes computing a contribution for embeddedness of the individual in the web of trust.

3. The method of claim 2, wherein the examination of the web of trust includes computing contributions for direct embeddedness of the individual in the web of trust and indirect embeddedness of the individual in the web of trust.

4. The method of claim 1, wherein the non-network analysis based measures include identity measures which reward the individual for association with user profiles including difficult to replicable elements.

5. The method of claim 1, wherein the non-network analysis based measures include verification of the attribute with information obtained from trusted sources outside of the web of trust.

6. The method of claim 1 wherein the estimate is computed using weighted contributions for direct embeddedness of the individual in the web of trust, indirect embeddedness of the individual in the web of trust, embeddedness of the individual social in networks other than the web of trust, identity measures which reward the individual for association with user profiles including difficult to replicable elements, and verification of the attribute with information obtained from trusted sources outside of the web of trust.

7. The method of claim 2, wherein contributions for direct embeddedness of the individual in the web of trust are determined according to a computation of the individual's modified indegree Bonacich centrality within the web of trust.

8. The method of claim 2, wherein contributions for indirect embeddedness of the individual in the web of trust are determined according to a computation of the individual's modified indegree Bonacich centrality within the web of trust modified so as to limit a total indirect embeddedness contribution per verifying member of the web of trust for the individual.

9. The method of claim 8, wherein contributions for indirect embeddedness are capped at a threshold.

10. The method of claim 1, wherein the estimate is computed through a scoresheet approach in which the individual mechanisms by which trustworthiness of the self-asserted attribute is measured are each allocated a specific number of scoresheet points and a credential score is a summed total of the scoresheet points.

11. The method of claim 10, in which contributions to the credential score for indirect embeddedness of the individual in the web of trust comprise a majority of the scoresheet points for the examination of a web of trust within which the individual is embedded.

12. The method of claim 10, wherein contributions to the credential score attributable to verification of the attribute with information obtained from trusted sources outside of the web of trust comprise a single largest component of the scoresheet points.

13. A computer-implemented method, comprising quantitatively measuring an individual's embeddedness within a social network and assigning a score thereto, combining said score with a quantitative measure of a veracity of the attribute's asserted value as determined through non-network based analysis to produce a combined score, and reporting said combined score as a measure of trustworthiness of a self-asserted attribute of the individual.

14. The method of claim 13, wherein measuring the individual's embeddedness within the social network includes determining contributions for the individual's direct embeddedness and indirect embeddedness in the social network.

15. The method of claim 14, wherein a contribution for the individual's direct embeddedness in the social network is determined by computing the individual's modified indegree Bonacich centrality within the social network.

16. The method of claim 13, wherein a contribution for the individual's indirect embeddedness in the social network is determined by computing the individual's modified indegree Bonacich centrality within the social network, wherein modification limits a total indirect embeddedness contribution per verifying member of the social network for the individual.

17. The method of claim 13, wherein the non-network analysis includes a quantitative contribution for identity measures indicative of the individual's association with user profiles including difficult to replicable elements.

18. The method of claim 13, wherein the non-network analysis includes verification of the attribute with information obtained from trusted sources outside of the social network.

19. The method of claim 13, wherein the combined score is computed through a scoresheet approach in which each quantitative measure is allocated a contribution to the combined score up to a threshold.

20. A computer-based method, comprising determining a quantitative measure of a trustworthiness of a self-asserted attribute of an individual through a combination of analysis of a social network of which the individual is a member and non-network based analyses, and reporting said measure.

21. A computer-based method, comprising determining a quantitative measure of a likelihood that an individual will repay a loan through a combination of analysis of a social network of which the individual is a member and non-network based analyses, and reporting said measure.
